(19) United States
(12) Patent Application Publication
(10) Pub. No.: US 2025/0125368 A1
(43) Pub. Date: Apr. 17, 2025

(54) CONDUCTIVE POLYMER-BASED ANODE AND LITHIUM BATTERY USING THE SAME

(71) Applicant: UIF (University Industry Foundation), Yonsei University, Seoul (KR)

(72) Inventors: Sang-Young LEE, Seoul (KR); Jeonghun KIM, Seoul (KR); Seung-Hyeok KIM, Seoul (KR); Minseok JEONG, Gyeonggi-do (KR); Young-Kuk HONG, Seoul (KR); Seong-Hyeon JUNG, Seoul (KR)

(73) Assignee: UIF (University Industry Foundation), Yonsei University, Seoul (KR)

(21) Appl. No.: 18/909,466

(22) Filed: Oct. 8, 2024

(30) Foreign Application Priority Data
Oct. 11, 2023 (KR) 10-2023-0134883
Oct. 25, 2023 (KR) 10-2023-0143632
Oct. 8, 2024 (KR) 10-2024-0136198
Oct. 8, 2024 (KR) 10-2024-0136200

(51) Int. Cl. H01M 4/62; H01M 4/02; H01M 4/04; H01M 4/38; H01M 10/0525

(52) U.S. Cl. CPC H01M 4/624; H01M 4/0404; H01M 4/382; H01M 10/0525; H01M 2004/027

(57) ABSTRACT

The lithium battery according to various aspects of the present invention can form a LiF-rich SEI that has excellent mechanical, chemical, and electrochemical stability and can induce uniform lithium ion flow, thereby effectively suppressing lithium dendrite formation and enabling excellent battery performance even after hundreds of charge and discharge cycles.

### TECHNOLOGY

The present invention relates to a conductive polymer-based anode and a lithium battery utilizing the same.

### TECHNOLOGY BEHIND THE INVENTION

With the rapid advancement of electronic device performance, there is an increasing need to develop high-performance secondary batteries to power them. For example, due to the explosive demand for electric vehicles, there is an urgent need to secure batteries with high energy density that can generate higher energy at the same weight. In response, batteries using lithium metal as the anode have been developed, but there is a problem of dendrite formation on the lithium electrode.

Dendrites are formed due to the uneven reduction electrodeposition of lithium ions from the surface of lithium metal, which lowers the Coulombic efficiency and charge/discharge cycle performance of the cell, causes capacity loss, and furthermore, if the dendrites continue to grow and touch the cathode, they can cause an internal short circuit, leading to cell explosion. As a result, batteries using lithium metal as the anode suffer from critical stability issues and have yet to be commercialized.

When lithium metal comes into contact with an electrolyte, it forms a passive electrolyte film (SEI), which is a reductive decomposition product, and if the film layer is electronically conductive, it can block further reductive decomposition reactions of the electrolyte, thereby improving the stability of the battery by uniformly electrodepositing lithium. However, the SEI layer is easily broken by the uneven growth of dendrites, and the stability of the cell is difficult to secure.

Therefore, in order to solve the above problems, there is an urgent need for research on electrodes and lithium batteries that have an SEI layer that can effectively suppress the cracking phenomenon caused by inhomogeneous dendrite growth, and furthermore, can effectively prevent the growth of inhomogeneous dendrites.

### INVENTION DESCRIPTION

### The Problem You want to Solve

One object of the present invention is to provide a lithium battery comprising a conductive polymer layer containing anionic functional groups on an anode collector and a fluorine-containing electrolyte layer, wherein such a lithium battery has excellent mechanical, chemical, and electrochemical stability and can form a LiF-rich SEI capable of inducing uniform lithium ion flow, thereby effectively suppressing lithium dendrite formation and having excellent battery performance even after hundreds of charge and discharge cycles. It is still another object of the present invention to provide a lithium battery comprising an anode comprising an anode active material layer containing anode active material particles on which a conductive polymer layer containing anionic functional groups is formed, wherein the anode according to the present invention has excellent slurry dispersibility, good applicability, good mechanical, chemical, and electrochemical stability on the surface of the particles, without the need for a separate coating material or binder. Such anode can also form a LiF-rich SEI that has excellent mechanical, chemical, and electrochemical stability and can induce a uniform flow of lithium ions, and can exhibit excellent performance as an anode due to its higher electronic conductivity and lower collector interfacial resistance than a conventional anode including a separate coating material or binder, and the lithium battery comprising the anode can effectively suppress the formation of lithium dendrites and have excellent battery performance even after hundreds of charge and discharge cycles.

### Solution to the Challenge

According to one aspect of the present invention,

Provided is an anode comprising: an anode collector; a conductive polymer layer containing anionic functional groups formed on said collector; and an anode.

The anionic functional group may comprise one or more selected from the group consisting of carboxylic acid groups, sulfonic acid groups, sulfuric acid groups, phosphonic acid groups, and ammonium groups.

Preferably, said anionic functional group may comprise a carboxylic acid group.

The conductive polymer may comprise one or more selected from the group consisting of polystyrene-based polymers, polythiophene-based polymers, polyaniline-based polymers, polypyrrole-based polymers, polyacetylene-based polymers, polyazine-based polymers, polyphenylene-based polymers, and polyselenophene-based polymers. The conductive polymer may include a polystyrene-based polymer and a polythiophene-based polymer.

Preferably, said conductive polymer may comprise a carboxylic acid group-containing polystyrene-based polymer and a polythiophene-based polymer.

Said carboxylic acid group-containing polystyrene-based polymer may be a copolymer or blend of polystyrenesulfonate and polyacrylic acid.

Preferably, said copolymer of polystyrenesulfonate and polyacrylic acid may be a block copolymer of polystyrenesulfonate and polyacrylic acid.

The thickness of the conductive polymer layer may be 5 μm or less.

The anode collector may comprise one or more of the following materials selected from the group consisting of copper (Cu), stainless steel, titanium (Ti), iron (Fe), cobalt (Co), nickel (Ni), aluminum, calcined carbon, and aluminum-cadmium alloys.

According to one other aspect of the present invention,

A lithium battery comprising: said anode; and a fluorine-containing electrolyte layer is provided.

The electrolyte layer may comprise a fluorine-containing lithium salt and a solvent.

Preferably, said fluorine-containing lithium salt may comprise lithium bis(trifluoromethanesulfonyl)imide (LiTFSI).

Preferably, said solvent may comprise an ether-based solvent.

The solid electrolyte interphase layer may further include a solid electrolyte interphase layer comprising lithium fluoride (LiF) between said conductive polymer layer and the electrolyte layer.

The X-ray photoelectron spectroscopy (XPS) F 1s spectrum of said solid electrolyte interfacial layer surface may have a peak of LiF at 685±1 eV.

The ratio of the intensity of the 689±1 eV peak (1689) to the intensity of the 685±1 eV peak (1685) in an X-ray photoelectron spectroscopy (XPS) F 1s spectrum of the surface of said solid electrolyte interfacial layer may be greater than 1.

Preferably, the conductive polymer layer may further comprise a lithium metal layer between said conductive polymer layer and the electrolyte layer.

The lithium metal layer may further include a solid electrolyte interphase layer comprising lithium fluoride (LiF) on said lithium metal layer.

According to another aspect of the present invention,

There is provided an anode comprising an anode collector and an anode active material layer formed on said collector, said anode active material layer comprising anode active material particles, said anode active material particles having a conductive polymer layer formed thereon containing anionic functional groups on a surface.

The anionic functional group may comprise one or more selected from the group consisting of carboxylic acid groups, sulfonic acid groups, sulfuric acid groups, phosphonic acid groups, and ammonium groups.

Preferably, said anionic functional group may comprise a carboxylic acid group.

The conductive polymer may comprise one or more selected from the group consisting of polystyrene-based polymers, polythiophene-based polymers, polyaniline-based polymers, polypyrrole-based polymers, polyacetylene-based polymers, polyazine-based polymers, polyphenylene-based polymers, and polyselenophene-based polymers.

Preferably, said conductive polymer may comprise a polystyrene-based polymer and a polythiophene-based polymer.

More preferably, said conductive polymer may comprise a carboxylic acid group-containing polystyrene-based polymer and a polythiophene-based polymer.

Said carboxylic acid group-containing polystyrene-based polymer may be a copolymer or blend of polystyrenesulfonate and polyacrylic acid.

Preferably, said copolymer of polystyrenesulfonate and polyacrylic acid may be a block copolymer of polystyrenesulfonate and polyacrylic acid.

The weight ratio of said conductive polymer layer to the anode active material particles may be from 1:5 to 70.

The anode active material layer may not include a conductive material.

The anode active material layer may not include a binder.

At the above anode active material loading amount of 4 mg/mL, the electronic conductivity may be greater than or equal to 15 S/cm.

Under the condition of the above anode active material loading amount of 4 mg/cm², the interfacial resistance may be 0.3 Ωcm or less.

According to another aspect of the present invention,

There is disclosed a lithium battery comprising: an anode; and an electrolyte layer.

The electrolyte layer may comprise a fluorine-containing lithium salt and a solvent.

The fluorine-containing lithium salt may comprise lithium bis(trifluoromethanesulfonyl)imide (LiTFSI).

The solvent may include an ether-based solvent.

The conductive polymer layer may further comprise a solid electrolyte interphase layer comprising lithium fluoride (LiF) on said conductive polymer layer.

According to another aspect of the present invention, A anodic slurry composition is provided comprising: a conductive polymer containing an anionic functional group; and anode active material particles.

The anionic functional group may comprise one or more selected from the group consisting of carboxylic acid groups, sulfonic acid groups, sulfuric acid groups, phosphonic acid groups, and ammonium groups.

The conductive polymer may include carboxylic acid group-containing polystyrene-based polymers and polythiophene-based polymers.

Said carboxylic acid group-containing polystyrene-based polymer may be a copolymer or blend of polystyrenesulfonate and polyacrylic acid.

The copolymer of polystyrenesulfonate and polyacrylic acid may be a block copolymer of polystyrenesulfonate and polyacrylic acid.

### Effect of Invention

The lithium battery according to one aspect of the present invention can form a LiF-rich SEI that has excellent mechanical, chemical, and electrochemical stability and can induce uniform lithium ion flow, thereby effectively suppressing lithium dendrite formation and enabling excellent battery performance even after hundreds of charge and discharge cycles.

The anode according to another aspect of the present invention can form a LiF-rich SEI that has excellent mechanical, chemical, and electrochemical stability and can induce uniform lithium ion flow without a separate coating material or binder, and can exhibit excellent performance as an anode due to its higher electronic conductivity and lower collector interfacial resistance than a conventional anode including a separate coating material or binder. In addition, the inclusion of the above anode can effectively suppress the formation of lithium dendrites, enabling excellent battery performance even after hundreds of charge and discharge cycles.

### SHORT DESCRIPTION OF THE DRAWING

FIG. 1 is a graph showing the Coulombic efficiency as a function of the number of charge/discharge cycles for coin cells fabricated in Example 1 and Comparative Examples 1 and 2.

FIG. 2 is an SEM image of the coin cell anode surface of Example 1 and Comparative Example 1.

FIG. 3 is an X-ray photoelectron spectroscopy (XPS) F 1s spectrum of the coin cell anode surface of Example 1 and Comparative Example 1.

FIG. 4 is a schematic illustration of an anode active material particle with a conductive polymer layer containing anionic functional groups, according to one embodiment of the present invention.

FIG. 5 is an image evaluating the applicability of the anode slurry compositions of Preparatory Examples 3 and 5.

FIG. 6 is an SEM image of the surface of an anode active material layer prepared using the anode slurry compositions of Preparatory Examples 3 and 5.

FIG. 7 is a voltage profile graph for the half cell containing the anode of Example 3 and Comparative Example 3.

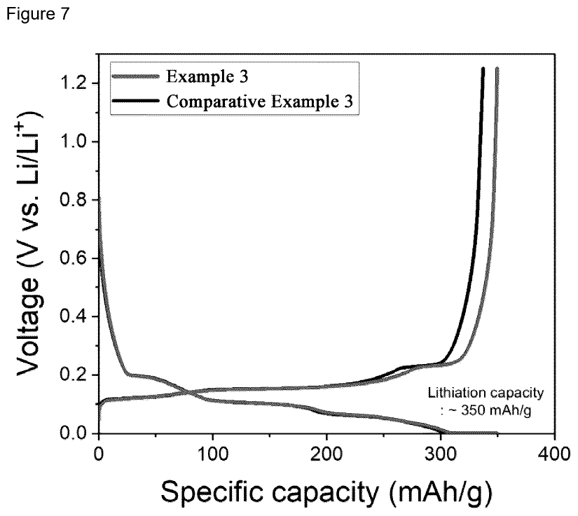

FIG. 8 is a graph of volumetric capacity and Coulombic efficiency as a function of the number of charge/discharge cycles for the coin cell of Example 4 and Comparative Examples 4 and 5.

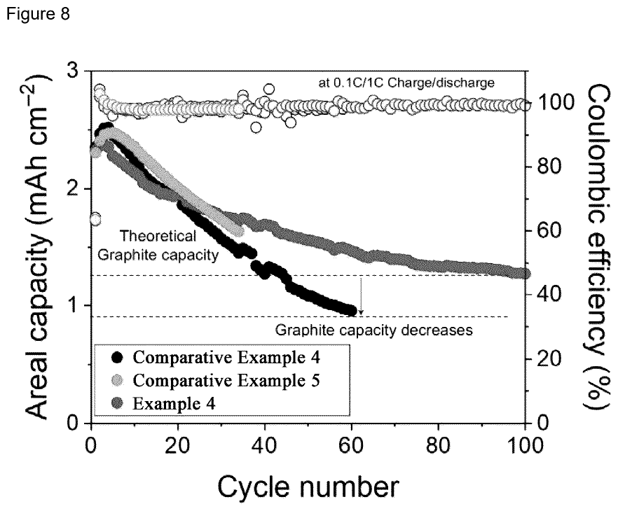

### SPECIFIC DETAILS FOR PRACTICING THE INVENTION

Unless otherwise defined herein, all technical and scientific terms have the same meanings as commonly understood by those skilled in the art to which this invention belongs. The terms used in the description herein are intended only to effectively describe certain embodiments and are not intended to limit the invention.

As used herein, singular forms may be intended to include plural forms unless the context otherwise dictates.

In addition, as used herein, numerical ranges include lower and upper limits and all values within those ranges, increments logically derived from the shape and width of the defined range, all values that are doubly bounded, and all possible combinations of upper and lower limits of differently bounded numerical ranges. Unless otherwise defined herein, the defined numerical range includes values outside the numerical range that are likely to occur due to experimental error or rounding of values.

As used herein, the term “comprising” (or comprise) is open-ended, with equivalent meanings to expressions such as “containing,” “having,” or “characterized by,” and does not exclude any element, material, or process not further enumerated.

Further, when a layer is referred to herein as being located “on top of” another layer, this includes not only when a layer abuts another layer, but also when there is one or more other layers between the two layers.

Further, as used herein, “˜-based polymer” is a broad concept that includes both “˜ polymer”, and/or “derivatives of ˜polymer”.

Hereinafter, a lithium battery according to one embodiment of the present invention will be described in more detail.

The present invention provides an anode comprising: an anode collector; a conductive polymer layer containing an anionic functional group formed on said collector; and a conductive polymer layer.

In accordance with one embodiment of the present invention, said anode collector may comprise one or more materials selected from the group consisting of copper (Cu), stainless steel, titanium (Ti), iron (Fe), cobalt (Co), nickel (Ni), aluminum, calcined carbon, and aluminum-cadmium alloys. The thickness of the anode collector may be from 1 to 100 micrometers, or from 2 to 50 micrometers, but is not limited thereto.

In accordance with one embodiment of the present invention, said conductive polymer layer comprises a conductive polymer containing anionic functional groups, wherein said conductive polymer may comprise one or more selected from the group consisting of a polythiophene-based polymer, a polyaniline-based polymer, a polypyrrole-based polymer, a polyacetylene-based polymer, a polyazine-based polymer, a polyphenylene-based polymer, and a polyselenophene-based polymer. One example of said conductive polymer is polyacetylene, polyaniline, polypyrrole, poly(1,4-phenylenevinylene), and poly(1,4-phenylenevinylene), poly(1,4-phenylene sulfide)), poly(fluorenyleneethynylene)), polythiophene, and PEDOT:PSS (poly(3,4-ethylenedioxythiophene)-poly(styrenesulfonate)), and the like. Preferably, said conductive polymer may comprise a polystyrene-based polymer and a polythiophene-based polymer. By including a layer of conductive polymer on said anode collector, electrodes having a LiF-rich SEI layer formed due to enhanced electron transport can be prepared, and lithium cells comprising such electrodes can exhibit significantly improved coulombic efficiency.

In accordance with one embodiment of the present invention, said anionic functional group may comprise at least one selected from the group consisting of carboxylic acid groups, sulfonic acid groups, sulfuric acid groups, phosphoric acid groups, and ammonium groups. Preferably, said anionic functional groups may comprise carboxylic acid groups. In this case, the formation of lithium dendrites can be effectively inhibited compared to conventional techniques using only simple conductive polymers, resulting in lithium cells with significantly improved coulombic efficiency even after hundreds of charge and discharge cycles. In particular, conventional conductive polymers that do not contain anionic functional groups are less likely to form the Li—F rich SEIs targeted by the present invention, resulting in cell performance and life characteristics that are significantly inferior to those of lithium batteries containing anodes according to one embodiment of the present invention.

In accordance with one preferred embodiment of the invention, said conductive polymers containing anionic functional groups may comprise anionic polystyrene-based polymers and polythiophene-based polymers, more particularly carboxylic acid group-containing polystyrene-based polymers and polythiophene-based polymers. The conductive polymers may include PEDOT:CP (Poly(3,4-ethylenedioxythiophene)-(Carboxylated polystyrene)), PEDOT:PSS:CP (Poly(3,4-ethylenedioxythiophene)-(poly(styrenesulfonate)-(Carboxylated polystyrene))) PEDOT:PSS:PAA (Poly(3,4-ethylenedioxythiophene)-(poly(styrenesulfonate)-Poly(acrylic acid))), PEDOT:P(SS-co-AA) (Poly(3,4-ethylenedioxythiophene)-(poly(styrenesulfonate-co-acrylic acid)), PEDOT:(PSS+PAA blend) (Poly(3,4-ethylenedioxythiophene)-(polystyrenesulfonate and polyacrylic acid)), and the like, and may include one or more selected from the group consisting of, but not limited to.

In particular, the anion-containing polystyrene-based polymer can be prepared by replacing the terminal functional groups of a conventional polystyrene-based polymer with an anion, more particularly a carboxyl group. Alternatively, but without limitation, the copolymer can be prepared by copolymerizing a conventional polystyrene-based monomer with an anion-containing monomer. Furthermore, the degree of substitution or the content of the anion-containing monomer in the copolymer can be easily adjusted, wherein the anion is the same as described above, and the anion-containing monomer can be an ethylenically unsaturated monomer containing the anion described above, specifically an acrylic-based monomer such as acrylic acid, methacrylic acid, etc. Furthermore, said copolymer may be a random copolymer or a block copolymer. The anion-containing polystyrene-based polymer prepared above can then be mixed or polymerized with a polythiophene-based polymer or monomer to prepare the conductive polymer described above, including but not limited to. In this case, the copolymerization or polymerization method can be a conventional method or a method known in the art.

In accordance with one embodiment of the present invention, the weight average molecular weight of the anion-containing polystyrene-based polymer may be from 1,000 to 800,000 g/mol, 5,000 to 500,000 g/mol, 10,000 to 300,000 g/mol, or 50,000 to 250,000 g/mol, but is not limited to the range above.

In accordance with one embodiment of the present invention, the weight average molecular weight of the conductive polymer containing said anionic functional groups may be, but is not limited to, 1,000 to 800,000 g/mol, 5,000 to 500,000 g/mol, 10,000 to 300,000 g/mol, or 50,000 to 250,000 g/mol.

In accordance with one embodiment of the present invention, the thickness of said conductive polymer layer may be 5 μm or less, 1 μm to 5 μm, 1 μm to 2 μm, 10 μm to 1 μm, 10 μm to 500 μm, or 20 μm to 200 μm.

A structure comprising said anode collector and a conductive polymeric layer on said collector may be defined as a unit anode collector.

In accordance with one embodiment of the present invention, said unit anode collector may further comprise an anode active material layer. Said anode active material layer may be any one of carbon selected from the group consisting of soft carbon, hard carbon, artificial graphite, natural graphite, expanded graphite, carbon fiber, black flammable carbon, carbon black, carbon nanotubes, acetylene black, ketene black, graphene, pleren, activated carbon, and mesocarbon microbeads; any one metal selected from the group consisting of silicon, tin, lithium, aluminum, silver, bismuth, indium, germanium, lead, platinum, titanium, zinc, manganese, cadmium, selenium, copper, cobalt, nickel, and iron; alloys comprising two or more of the above metals; and oxides of one or more of the above metals; and preferably, but not limited to, a lithium metal. The anode active material layer can be used with any material, content, dosage, etc. that is conventionally used or known in the art.

The present invention also provides a lithium battery comprising: an anode collector; a conductive polymer layer containing anionic functional groups formed on said collector; and a fluorine-containing electrolyte layer.

In accordance with one embodiment of the present invention, the lithium battery may comprise a structure with an anode collector, a conductive polymer layer, and an electrolyte layer stacked sequentially, or may comprise a structure with an anode collector, a conductive polymer layer, a solid electrolyte interphase layer (SEI), and an electrolyte layer stacked sequentially.

The anode collector; and the conductive polymer layer containing anionic functional groups formed on the collector; are as described in the construction of the anode above, and reference is hereby made to that section for a detailed description.

In accordance with one embodiment of the present invention, said electrolyte layer may comprise an electrolyte solution containing a fluorine-containing lithium salt and a solvent. In accordance with one embodiment of the present invention, said fluorine-containing lithium salts can be dissolved in a solvent to act as a source of lithium ions in the cell, enabling basic lithium cell operation and facilitating the transfer of lithium ions between the cathode and anode. Non-limiting examples of the above lithium salts include LiPF₆, LiBF₄, LiSbF₆, LiAsF₆, LiN(SO₂F)₂ (LiFSI, Li bis(fluorosulfonyl)imide), LiN(SO₂CF)₃₂ (LiTFSI), LiN(SOCF₂₂₅₂) (LiPFSI) LiCF₃SO₃, LiCF₄₉SO₃ and LiN(CFₓ₂ₓ₊₁SO₂) (CF_{y2y+1}SO₂) (wherein x and y are natural numbers), and may include any one or two or more combinations thereof selected from the group consisting of. Preferably, said fluorine-containing lithium salt may comprise lithium bis(trifluoromethanesulfonyl)imide (LiTFSI). The concentration of said lithium salt can be used in the range of 0.1 M to 5.0 M or 0.1 M to 2.0 M in said electrolyte.

In accordance with one embodiment of the present invention, said solvent may be a non-aqueous electrolyte, and may be a carbonate, ester, ether, ketone, alcohol, or non-protonated solvent, and may be used alone or in a mixture of two or more of said solvents, the mixing ratio being readily adjustable depending on the intended cell performance. For example, the solvent may be N-methyl-2-pyrrolidinone, propylene carbonate, ethylene carbonate, butylene carbonate, dimethyl carbonate, diethyl carbonate, ethylmethyl carbonate, γ-butylolactone, 1,2-dimethoxyethane, 1,2-diethoxyethane, Tetrahydroxy franc, 2-methyl tetrahydrofuran, dimethyl sulfoxide, 1,3-dioxolane, 4-methyl-1,3-dioxene, dimethylether, diethyl ether, dibutyl ether, tetraglime, diglime, dimethoxyethane, 2-methyltetrahydrofuran, polyethylene glyldimethyl ether, tetrahydrofuran, formamide, dimethylformamide, acetonitrile, nitromethane, methyl formate, methyl acetate, phosphoric acid triesters, trimethoxymethane, dioxolane derivatives, sulfuran, methylsulfuran, 1,3-dimethyl-2-imidazolidinone, propylene carbonate derivatives, tetrahydrofuran derivatives, ether, methyl propionate, ethyl propionate, and solvents known in the art may be used, including, but not limited to, ethyl propionate.

In accordance with one embodiment of the present invention, said solvent may comprise an ether-based solvent. Ether-based solvents include diethyl ether, dipropyl ether, dibutyl ether, dimethoxymethane, trimethoxymethane, dimethoxyethane, diethoxyethane, dimethoxypropane, dioxolane, methyldioxolane, oxane, dioxane, trioxane, tetrahydrofuran, dihydropyran, tetrahydropyran, methyltetrahydrofuran, furan, methylfuran, diethylene glycol dimethyl ether, triethylene glycol dimethyl ether, tetraethylene glycol dimethyl ether, ethylene glycol divinyl ether, diethylene glycol divinyl ether, triethylene glycol divinyl ether, dipropylene glycol dimethylene ether, and butylene glycol ether, and may be any one or more combinations selected from the group consisting of the same, preferably a mixture of 1,3-dioxolane and dimethyl ether.

In accordance with one embodiment of the present invention, said electrolyte layer may further comprise a nitrogen-based compound. Said nitrogenous compounds may include lithium nitrate, lithium bis fluorosulfonyl imide, lithium bis trifluoromethane sulfonimide, caprolactam (e-Caprolactam), N-methyl-e-caprolactam, Triethylamine, and Tributylamin, and the like, and may be at least one selected from the group consisting of N-methyl-caprolactam, Triethylamine, and Tributylamin, and may preferably be lithium nitrate (LiNO₃). Said nitrogenous compound may be included in an amount of 0.1 to 5 wt % or 1 to 3 wt % based on the total weight of said electrolyte layer.

According to one embodiment of the present invention, the solid electrolyte interfacial layer (SEI) may further comprise a solid electrolyte interfacial layer (SEI) comprising lithium fluoride (LiF) between the conductive polymer layer and the electrolyte layer, more specifically, a solid electrolyte interfacial layer rich in lithium fluoride (LiF) (LiF-rich SEI). The LiF-rich SEI has the advantage of having a lower swelling rate than the organic SEI, resulting in better mechanical stability, faster desolvation rate, and smaller electrolytic resistance. Moreover, the formation of LiF-rich SEI enables smooth diffusion of lithium ions on the surface of the lithium electrode and flat electrodeposition of lithium ions, effectively suppressing the formation of dendrites, thus enabling battery performance such as excellent coulombic efficiency even after hundreds of charge and discharge cycles.

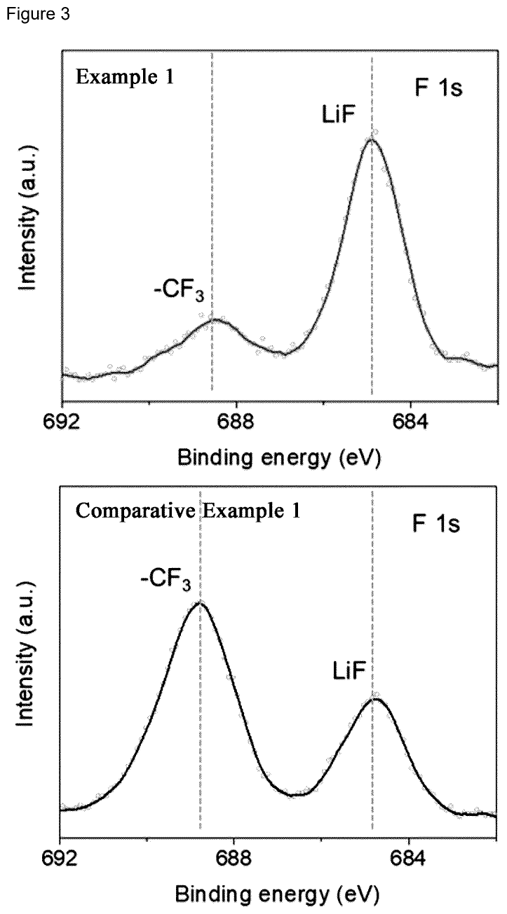

X-ray photoelectron spectroscopy (XPS) F 1s spectra of the coin cell anode surface of Example 1 and Comparative Example 1 according to one embodiment of the present invention are shown in FIG. 3. The X-ray photoelectron spectroscopy (XPS) F 1s spectrum of said solid electrolyte interfacial layer surface may have a peak of LiF at 685±1 eV. Specifically, the ratio of the intensity of the 689±1 eV peak (1689) to the intensity of the 685±1 eV peak (1685) in the X-ray photoelectron spectroscopy (XPS) F 1s spectrum of the solid electrolyte interfacial layer surface may be greater than or equal to 1, greater than or equal to 1.1, greater than or equal to 1.2, greater than or equal to 1.5, greater than or equal to 1.8, greater than or equal to 2, greater than or equal to 2.5, or greater than or equal to 3, wherein the upper limit is not substantially limited but may be less than or equal to 50, or less than or equal to 100.

According to another embodiment of the present invention, the lithium battery may comprise a structure with an anode collector, a conductive polymer layer, a lithium metal layer, and an electrolyte layer stacked sequentially, or a structure with an anode collector, a conductive polymer layer, a lithium metal layer, a solid electrolyte interfacial (SEI) layer, and an electrolyte layer stacked sequentially. Preferably, the lithium battery may be a lithium metal battery.

In accordance with one embodiment of the present invention, said lithium metal layer may have a thickness of 1 to 800 μm, or 5 to 500 μm, or 10 to 250 μm, but is not limited thereto, and may be readily adjusted according to the properties desired to be produced.

The lithium battery according to one embodiment may further comprise a cathode in addition to the structure described above, and may optionally further comprise a separator interposed between said cathode and anode.

The cathode may comprise a cathode collector and a cathode active material layer formed on said cathode collector. Non-limiting examples of the cathode collector may include a foil made of aluminum, nickel, or a combination thereof, and the thickness of the cathode collector is not particularly limited, but may be from 3 to 500 micrometers. The cathode active material may include solvent binders, conductors, dispersants, and the like as desired.

The cathode active material may be any conventional cathode active material used in the art, as long as the material is capable of reversible insertion and dissociation of lithium ions, by way of non-limiting example, Lithium cobalt oxide (LiCoO₂), spinel crystalline lithium manganese oxide (LiMnO₂₄), lithium manganese oxide (LiMnO₂), lithium nickel oxide (LiNiO₂), lithium iron phosphate (LiFePO), lithium iron phosphate; LiFePO₄), lithium manganese phosphate (LiMnPO₄), lithium cobalt phosphate (LiCoPO₄), lithium iron pyrophosphate; Li₂FePO₂₇), lithium niobate complex oxide (LiNbO₂), lithium ferric complex oxide (LiFeO₂), lithium magnesium complex oxide (LiMgO₂), lithium copper complex oxide (LiCuO₂), lithium zinc complex oxide (LiZnO₂), lithium molybdate complex oxide (LiMoO₂), lithium tantalate complex oxide (LiTaO₂), and lithium tungstate complex oxide (LiWO₂), Lithium permanganate nickel cobalt complex oxide (xLiMnO₂₃(1−x)LiMn1−y−zNiyCozO₂), Lithium nickel cobalt aluminum complex oxide (LiNi_{0.8}Co_{0.15}AlO_{0.052}), Lithium nickel cobalt manganese complex oxide (LiNi_{0.33}CoMnO_{0.330.332}, LiNi_{0.4}CoMnO_{0.20.42}, LiNi_{0.5}CoMn_{00.20.32}, LiNi_{0.6}CoMnO_{0.20.22}, LiNi_{0.7}CoMnO_{0.150.152}, LiNi_{0.8}CoMnO_{0.10.12}), and nickel manganese oxide (LiNiMnO_{0.51.54}).

The conductive materials may include carbon black, such as carbon black, acetylene black, ketchen black, channel black, furnace black, lamp black, summer black, etc.; conductive fibers, such as carbon fiber, metal fiber, etc.; metal powders, such as carbon fluoride, aluminum, nickel powder, etc.; conductive whiskey, such as zinc oxide, potassium titanate, etc.; conductive metal oxides, such as titanium oxide; conductive materials, such as polyphenylene derivatives, etc., but are not particularly limited as long as they are conductive without causing chemical changes in the cell.

The cathode collector and the cathode active material layer can be used with conventionally used or known materials, contents, capacities, and the like, and will not be described herein.

The separator is a separator having micropores through which ions can pass, which may be, by way of non-limiting example, one or two or more combinations selected from the group consisting of fiberglass, polyester, polyethylene, polypropylene, and polytetrafluoroethylene, and may be in the form of a non-woven or woven fabric. Specifically, but not exclusively, polyolefin-based polymeric separators such as polyethylene and polypropylene may be used. In addition, separators coated with compositions containing ceramic components or polymeric materials to provide heat resistance or mechanical strength may also be used, optionally in a monolayer or multilayer structure, and any separator known in the art may be used, including, but not limited to, those known in the art.

The lithium battery may be made in a shape conventionally used in the art, and is not limited in appearance to the application of the battery, and may be, for example, cylindrical, angular, pouch-shaped, or coin-shaped, using a can.

In particular, by forming a solid electrolyte interface film (SEI) rich in lithium fluoride (LiF), the lithium battery according to one modality has a low surface diffusion barrier energy on the surface of the lithium metal anode, enabling smooth diffusion of lithium ions, thereby effectively suppressing dendrite formation by electrodepositing lithium ions flatly on the anode surface. As a result, battery performance such as excellent coulombic efficiency can be realized even after hundreds of charge and discharge cycles.

In one aspect, the present invention provides an anode slurry composition comprising a conductive polymer containing anionic functional groups and anode active material particles.

The conductive polymer is the same as previously described, so we will refer to that description for details.

In accordance with one embodiment of the present invention, said anode active material particles may be any conventionally used anode active material, for example, any carbon selected from the group consisting of soft carbon, hard carbon, artificial graphite, natural graphite, expanded graphite, carbon fiber, anthracite, carbon black, carbon nanotubes, acetylene black, ketchen black, graphene, fluorene, activated carbon, and mesocarbon microbeads; any one metal selected from the group consisting of, but not limited to, silicon, tin, lithium, aluminum, silver, bismuth, indium, germanium, lead, platinum, titanium, zinc, manganese, cadmium, selenium, copper, cobalt, nickel, and iron; alloys comprising two or more of the foregoing metals; and oxides of one or more of the foregoing metals. Further, the anode active material particles may have an average particle diameter of 0.1 to 50 micrometers, 5 to 30 micrometers, but are not limited thereto.

In the anode slurry composition according to one embodiment of the present invention, the weight ratio of said conductive polymer to anode active material particles may be 0 greater than 10 and less than or equal to: 90 greater than or equal to 100, or 1:2 to 100, or 1:5 to 70, or 1:15 to 60, or 1:15 to 40.

In accordance with one embodiment of the present invention, the anode slurry composition may further comprise other additives, such as solvents, binders, conductors, dispersants, and the like, in addition to the conductive polymer and anode active material particles described above.

The solvent may be a water-soluble solvent, such as water, or an organic solvent or a mixture of an organic solvent and water, as desired. Examples of such organic solvents include, but are not limited to, DMSO, alcohols, ethers, esters, ketones, and hydrocarbons. The binder may include, but is not limited to, polyvinylidene fluoride (PVdF) or styrene-butadiene rubber (SBR)/carboxy methyl cellulose (CMC).

The conductive materials may include carbon black, such as carbon black, acetylene black, ketchen black, channel black, furnace black, lamp black, summer black, etc.; conductive fibers, such as carbon fiber, metal fiber, etc.; metal powders, such as carbon fluoride, aluminum, nickel powder, etc.; conductive whiskey, such as zinc oxide, potassium titanate, etc.; conductive metal oxides, such as titanium oxide; conductive materials, such as polyphenylene derivatives, etc., but are not particularly limited as long as they are conductive without causing chemical changes in the cell.

In accordance with one preferred embodiment of the present invention, the anode slurry composition may comprise no separate binder or coating material. The composition may exhibit excellent dispersibility, applicability, low interfacial resistance with the substrate, as well as excellent electronic conductivity without including binders or coating materials. In accordance with one preferred embodiment of the present invention, said anode slurry composition may have a solids (dry weight) content of 20 wt % or more, 45 wt % or more, 50 wt % or more, 60 wt % or more, and may have an upper limit of 95 wt % or less, or 99 wt % or less, although not limited thereto.

The present invention also provides an anode comprising an anode collector and an anode active material layer formed on said collector, said anode active material layer comprising anode active material particles, said anode active material particles having a conductive polymer layer containing anionic functional groups on their surface.

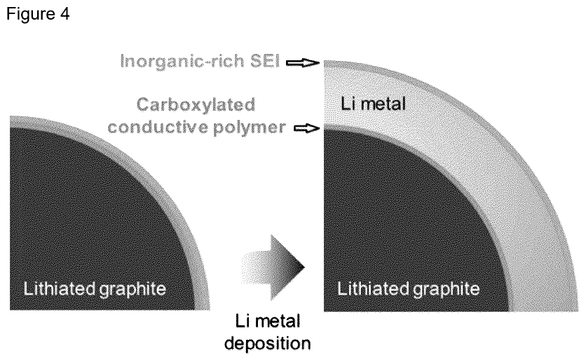

A schematic of an anode active material particle with a conductive polymer layer containing anionic functional groups according to one embodiment of the present invention is shown in FIG. 4.

In accordance with one embodiment of the present invention, said anode collector may comprise one or more materials selected from the group consisting of copper (Cu), stainless steel, titanium (Ti), iron (Fe), cobalt (Co), nickel (Ni), aluminum, calcined carbon, and aluminum-cadmium alloys. The thickness of the anode collector may be from 1 to 100 micrometers, or from 2 to 50 micrometers, but is not limited thereto.

In accordance with one embodiment of the present invention, the anode active material layer can be prepared by applying and drying the anode slurry composition described above. The method of application may utilize any conventionally used method, and may include, but is not limited to, slot-die coating, pipetting coating, doctor-blade, blade-coating, bar-coating, rod-coating, roll-coating, spray-coating, dispensing, stamping, imprinting, inkjet printing, or nozzle printing. Furthermore, the drying can be accomplished using any conventional drying method, for example, but not limited to, drying in an oven at 60° C. or higher for at least 10 minutes or for at least 1 hour. The above steps can be used to prepare an anode active material layer comprising anode active material particles formed on a surface of a conductive polymer layer containing anionic functional groups. In accordance with one embodiment of the present invention, the anode active material layer may not include a coating or binder. The anode active material layer may exhibit low interfacial resistance with the substrate and excellent electronic conductivity without including a binder or coating material.

In accordance with one embodiment of the present invention, said conductive polymer layer may comprise a conductive polymer containing anionic functional groups, said conductive polymer being the same as described above and therefore omitted. By including a conductive polymer layer on said anode collector, electrodes with an enhanced electron transport, resulting in a LiF-rich SEI layer, can be prepared, and lithium cells comprising the same can exhibit significantly improved coulombic efficiency.

In accordance with one embodiment of the present invention, the above-described conductive polymer layer may be formed on the surface of said anode active material particles, and said conductive polymer layer may realize the properties of the present invention just by being formed, The thickness of said conductive polymer layer is not particularly limited, but may be 5 μm or less, 1 μm to 5 μm, 1 μm to 500 μm, or 5 μm to 100 μm, and may be equivalent to the thickness of a conductive polymer layer formed by conventional or known techniques.

In accordance with one embodiment of the present invention, said anode active material layer may have a thickness of 0.1 to 800 μm, 1 to 500 μm, or 5 to 300 μm.

In accordance with one embodiment of the present invention, the weight ratio of said conductive polymeric layer to anode active material particles may be 0 or more than 10 but less than: 90 but less than 100, or 1:2 to 100, 1:5 to 70, 1:15 to 60, or 1:15 to 40. In accordance with one embodiment of the present invention, the electronic conductivity can be as high as 15 S/cm or more, 20 S/cm or more, 25 S/cm or more, or 20 to 60 S/cm at an active material loading amount of 4 mg/mL.

In accordance with one embodiment of the present invention, the interfacial resistance can be as low as 0.4 Ωcm, as low as 0.3 Ωcm, as low as 0.2 Ωcm at an active substance loading amount of 4 mg/mL.

The present invention also provides a lithium battery comprising: an anode collector; an anode active material layer formed on said collector; and an electrolyte layer, said anode active material layer comprising anode active material particles, said anode active material particles having a conductive polymer layer containing anionic functional groups on their surface.

Here, the characteristics of the electrolyte layer, the types of fluoride-containing lithium salts and solvents used in the electrolyte, nitrogen-based compounds that may be added to the electrolyte layer, and the further inclusion of a solid electrolyte interphase layer comprising lithium fluoride (LiF), The nature of the peaks in X-ray photoelectron spectroscopy (XPS) analysis of the surface of the solid electrolyte interphase layer, the cathode collector, cathode active material, conductor, separator, and the shape of the battery in relation to the cathode included in the battery are the same as those described in the above-mentioned lithium battery invention, and will not be described in detail.

Embodiments of the present invention will be described in detail below with reference to the accompanying drawings. However, this is provided to facilitate the practice of those having ordinary knowledge in the technical field to which the invention belongs, and the invention may be implemented in many different forms, and the ideas of the invention are not necessarily limited to the embodiments.

### Preparatory Example 1

Preparation of Carboxyl Group-Containing Conductive Polymers PEDOT:P(SS-co-AA) (Poly(3,4-ethylenedioxythiophene)-(poly(styrenesulfonate-co-acrylic acid)) was prepared by polymerization of Poly(styrenesulfonate-block-poly(acrylic acid) (sigma aldrich) and 3,4-Ethylenedioxythiophene in a 1:1 weight ratio. The weight average molecular weight of the prepared polymer measured by GPC was about 100,000 g/mol.

### Preparatory Example 2

PEDOT:(PSS+PAA blend) (Poly(3,4-ethylenedioxythiophene)-(polystyrenesulfonate and polyacrylic acid)) was prepared in the same way as in Preparatory Example 1, except that a blend of poly(styrenesulfonate) and poly(acrylic acid) was used instead of poly(styrenesulfonate-block-poly(acrylic acid)).

### Example 1

An anode collector was prepared by blade casting the PEDOT:P(SS-co-AA) solution prepared in Preparatory Example 1 above on a copper (Cu) thin film with a thickness of 10 μm, which is the anode collector, to form a conductive polymer layer of 100 nm.

A polyethylene separator with a thickness of 20 μm was interposed between the anode collector prepared above and a lithium metal with a thickness of 200 μm, and then an electrolyte solution prepared by mixing DOL (1,3-Dioxolane):DME (DiMethyl Ether) in a volume ratio of 1:1 (v:v) as an electrolyte with 2 wt. % LiNO₃ and LiTFSI 1.0 M of electrolyte solution was added to prepare CR2023 coin cell (Li∥Cu cell).

### Example 2

The CR2023 coin cell (Li∥Cu cell) was prepared under the same conditions as in Example 1, except that the PEDOT:(PSS+PAA) solution prepared in Preparatory Example 2 was used instead of the PEDOT:P(SS-co-AA) solution prepared in Preparatory Example 1.

### Comparison Example 1

The same procedure was performed as in Example 1 above, except that only copper (Cu) with a thickness of 10 μm was used as the anode collector.

### Comparison Example 2

The formation of the conductive polymer layer was performed as in Example 1 above, except that a non-carboxylated PEDOT: PSS solution (Sigma-Aldrich) was used instead of a PEDOT:P(SS-co-AA) solution.

### [Evaluation Example 1] Battery Performance

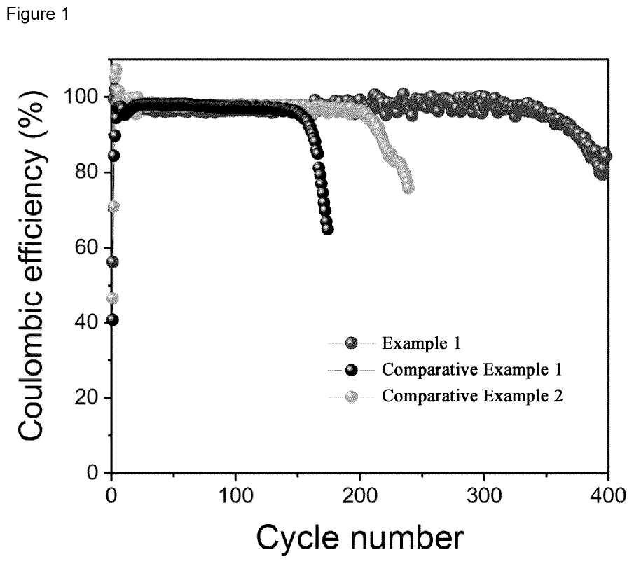

To test the cell performance of the above embodiments and comparative embodiments, a graph showing the variation of Coulombic efficiency as a function of the number of charge/discharge cycles at room temperature (25° C., 1 mA/cm²/1 mAh/cm²) is shown in FIG. 1.

As shown in FIG. 1, the point at which the Coulombic efficiency drops below 80% is 400 cycles for the embodiment, compared to 150 cycles for Comparative Example 1 and 220 cycles for Comparative Example 2. This confirms that the lithium battery comprising a conductive polymer layer according to one embodiment maintains a high Coulombic efficiency even after hundreds of charge/discharge cycles.

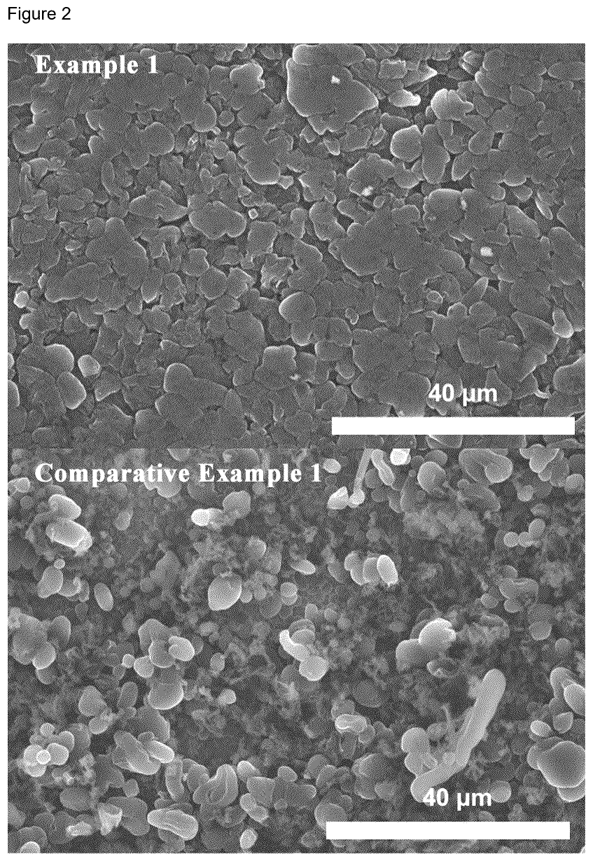

To evaluate the extent to which lithium plating occurs in the above embodiments and comparative examples, the tested coin cell was dissected and the surface of the anode was analyzed by SEM, and the morphology image is shown in FIG. 2. As shown in FIG. 2, it is confirmed that lithium electrodeposition with a smaller surface area occurs in the case of Example 1 compared to Comparative Example 1.

In addition, to confirm the formation of a solid electrolyte interphase layer (SEI), the anode of the tested coin cell was analyzed by XPS, and the intensity of the 689±1 eV peak corresponding to —CF₃ (I₆₈₉) and the intensity of the 685±1 eV peak corresponding to LiF (I₆₈₅) in the F 1s spectrum were compared. For Example 1, I₆₈₅ is approximately 3.1 times higher than I₆₈₉, while for Comparison 1, I₆₈₉ is higher than I₆₈₅.

This confirms that the SEI formed in Example 1 forms a LiF-rich SEI, and the anode according to one embodiment can effectively suppress the formation of dendrites by electrodepositing Li-ions flatly due to the low surface diffusion barrier energy of the anode surface, such as an ideal SEI, and thus exhibits excellent battery performance even after hundreds of charge and discharge cycles as shown in FIG. 1.

### [Preparatory Example 3] Preparation of Anode Slurry Composition

Natural graphite (average particle size 20 μm) and PEDOT:P(SS-co-AA) of Preparatory Example 1 above were combined to meet a weight ratio of 95:5 based on dry weight, and an anode slurry composition of 80 wt % solids was prepared by mixing uniformly with water in a mixer.

### [Preparatory Example 4] Preparation of Anode Slurry Composition

The anode slurry composition was prepared in the same manner as in Preparatory Example 3, except that the PEDOT:(PSS+PAA blend) of Preparatory Example 2 was used instead of Preparatory Example 1.

### [Preparatory Example 5] Preparation of Anode Slurry Composition

An anode slurry composition was prepared by uniformly mixing the same natural graphite: coating material (carbon black Super C65):binder (a mixture of styrene-butadiene rubber (SBR) and carboxymethylcellulose (CMC) in a weight ratio of 1:1) in a mixer in a weight ratio of 95:2:3 as in Preparatory Example 3.

### [Preparatory Example 6] Preparation of Anode Slurry Composition

An anode slurry composition was prepared as in Preparatory Example 3 except that anion-free PEDOT: PSS (Sigma-Aldrich) was used instead of PEDOT:P(SS-co-AA) used in Preparatory Example 3.

The anode slurry compositions of Preparatory Examples 3 and 5 were applied with a doctor blade to a copper (Cu) thin film having a thickness of 10 μm to form an anode active material layer having a thickness of about 100 μm, and the applicability of the anode active material layer was evaluated.

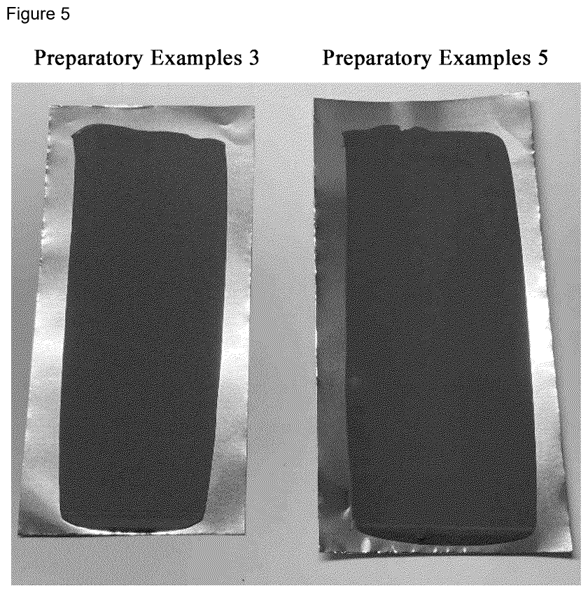

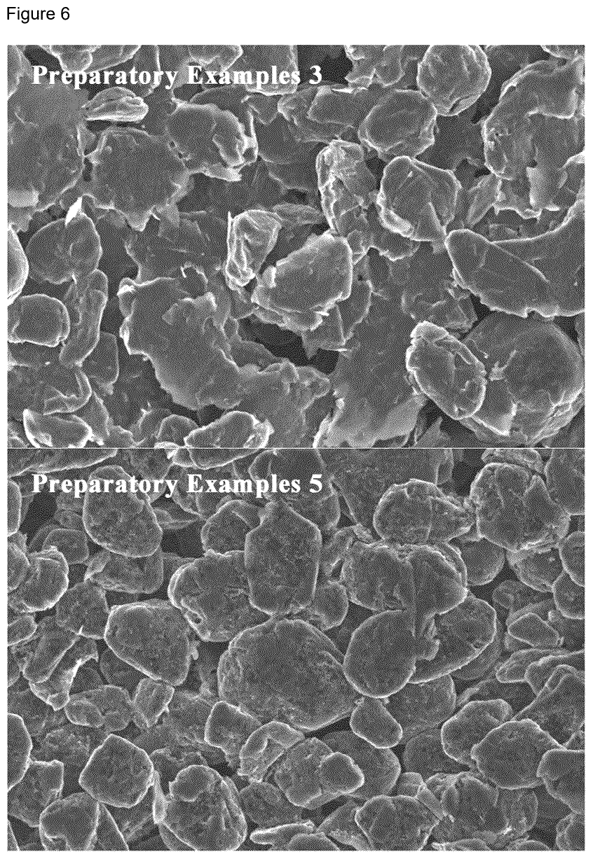

As shown in FIGS. 5 and 6, the anode slurry compositions of Preparatory Examples 3 and 5 both exhibit good dispersibility and applicability, particularly in the case of Preparatory Example 3, where a conductive polymer layer was uniformly formed around the graphite active material particles.

### [Example 3] Preparation of the Anode

The anode slurry composition of Preparatory Example 3 was applied to a copper (Cu) thin film with a thickness of 10 μm, which is the anode collector, and dried with a doctor blade to form an anode active material layer with a thickness of about 50 μm, wherein the loading amount of graphite, the anode active material, was 4 mg/cm. Thus, an anode comprising an anode active material layer was prepared.

### [Example 4] Preparation of the Anode

Example 3 was performed as in Example 1, except that the graphite loading amount was adjusted to 3.5 mg/cm, and the same active material loading amount was used.

### [Example 5] Preparation of the Anode

The anode was prepared in the same manner as in Example 3, except that the anode slurry composition of Preparatory Example 4 was used instead of that of Preparatory Example 3.

### [Comparative Example 3] Preparation of an Anode

The same procedure was performed as in Example 3, except that the anode slurry composition of Preparatory Example 5 was used instead of that of Preparatory Example 3, with the same amount of active material loading.

### [Comparative Example 4] Preparation of the Anode

The same active material loading was performed as in Example 3 above, except that the graphite loading was adjusted to 3.5 mg/cm.

### [Comparative Example 5] Preparation of the Anode

The anode was prepared using the same active material loading as in Comparative Example 4, except that the anode slurry composition of Preparatory Example 6 was used instead of that of Preparatory Example 3.

While the invention has been described above by way of limited embodiments, which are provided for a more general understanding of the invention, the invention is not limited to the above embodiments, and various modifications and variations from these descriptions will be apparent to one having ordinary skill in the field to which the invention belongs. Accordingly, the idea of the invention is not to be limited to the described embodiments, and all equivalents or equivalent variations thereof, as well as the claims of the patent hereinafter described, will be said to fall within the scope of the idea of the invention.

What is claimed is:

1. An anode comprising:
an anode collector; and
a conductive polymer layer containing anionic functional groups formed on said collector.

2. The anode of claim 1, wherein said anionic functional group comprises at least one selected from the group consisting of a carboxylic acid group, a sulfonic acid group, a sulfonic acid group, a phosphonic acid group, and an ammonium group.

3. The anode of claim 1, wherein said anode comprises at least one of said conductive polymer selected from the group consisting of a polythiophene-based polymer, a polyaniline-based polymer, a polypyrrole-based polymer, a polyacetylene-based polymer, a polyazine-based polymer, a polyphenylene-based polymer, and a polyselenophene-based polymer.

4. The anode of claim 1, wherein said conductive polymer comprises a carboxylic acid group-containing polystyrene-based polymer and a polythiophene-based polymer.

5. The anode of claim 1, wherein said carboxylic acid group-containing polystyrene-based polymer is a block copolymer or blend of polystyrenesulfonate and polyacrylic acid.

6. The lithium battery comprising:
the anode of claim 1; and
a fluorine-containing solid electrolyte layer.

7. The lithium battery of claim 6, wherein the X-ray photoelectron spectroscopy (XPS) F 1s spectrum of the surface of the interfacial layer of said solid electrolyte layer shows a peak of LiF at 685±1 eV.

8. The lithium battery of claim 8, wherein the ratio of the intensity of the 689±1 eV peak (1689) to the intensity of the 685±1 eV peak (1685) in an X-ray photoelectron spectroscopy (XPS) F 1s spectrum of the surface of the interfacial layer of said solid electrolyte is greater than or equal to 1.

9. The lithium battery of claim 6, further comprising a lithium metal layer between said conductive polymer layer and said electrolyte layer.

10. An anode electrode comprising:
an anode collector; and
an anode active material layer formed on said collector,
wherein said anode active material layer comprises anode active material particles, and
wherein said anode active material particles comprise a conductive polymer layer containing anionic functional groups formed on their surface.

11. The anode of claim 10, wherein said anionic functional group comprises at least one selected from the group consisting of a carboxylic acid group, a sulfonic acid group, a sulfonic acid group, a phosphonic acid group, and an ammonium group.

12. The anode of claim 10, wherein said conductive polymer comprises at least one selected from the group consisting of a polythiophene-based polymer, a polyaniline-based polymer, a polypyrrole-based polymer, a polyacetylene-based polymer, a polyazine-based polymer, a polyphenylene-based polymer, and a polyselenophene-based polymer.

13. The anode of claim 10, wherein said conductive polymer comprises a carboxylic acid group-containing polystyrene-based polymer and a polythiophene-based polymer.

14. The anode of claim 10, wherein said carboxylic acid group-containing polystyrene-based polymer is a block copolymer or blend of polystyrenesulfonate and polyacrylic acid.

15. The anode of claim 10, wherein the weight ratio of the conductive polymer layer to the anode active material particles is from 1:5-70.

16. The anode of claim 10, wherein said anode active material layer is free of a conductive material.

17. The anode of claim 10, wherein said anode active material layer is binder free.

18. The anode of claim 10, wherein said anode has an electronic conductivity of 15 S/cm or more and an interfacial resistance of 0.3 Qu or less under the condition of the above anode active material loading amount of 4 mg/cm².

19. The lithium battery comprising the anode of claim 10; and an electrolyte layer.
